(19) United States
(12) Patent Application Publication
(10) Pub. No.: US 2006/0273986 A1
(43) Pub. Date: Dec. 7, 2006

(54) Method for driving plasma display panels

(75) Inventor: Chao-Hung Hsu, Ta Li City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Chunghwa Picture Tubes, Ltd.

(21) Appl. No.: 11/142,512

(22) Filed: Jun. 1, 2005

(51) Int. Cl. G09G 3/28

(52) U.S. Cl. 345/60

(57) ABSTRACT

A method for driving plasma display panels (PDPs) includes dividing a plasma display panel having stripe ribs into at least two scanning regions. Each of the scanning regions has a plurality of scan and common electrodes, and these electrodes are arranged in an interlaced fashion according to an electrode arrangement sequence. Then, the emitting cells in each scanning region are addressed, and a scanning direction of each scanning region corresponds to the electrode arrangement sequence of the same scanning region.

### RELATED APPLICATIONS

The present application is based on, and claims priority from, Taiwan Application Serial Number 94102939, filed Jan. 31, 2005, the disclosure of which is hereby incorporated by reference herein in its entirety.

### BACKGROUND

1. Field of Invention

The present invention relates to a method for driving a plasma display panel.

2. Description of Related Art

In a plasma display panel (PDP), visible light is emitted from fluorescent members excited by ultraviolet (UV) rays that are generated by gas discharge. Generally, the PDP adopts a three-electrode structure, including a common electrode, a scan electrode and an address electrode.

FIG. 1 is a schematic top view showing the electrode structure of a conventional PDP, which has stripe ribs. Referring to FIG. 1, the electrode structure is mostly formed on an upper substrate, including a scan electrode 102 and a common electrode 104. An emitting cell 100 is a division formed by the stripe ribs 116 of the lower substrate and the foregoing electrode structure of the upper substrate structure, such as the square area enclosed by dotted lines illustrated in FIG. 1.

When a voltage is applied to the emitting cell 100, discharge takes place between the electrodes and electric fields are formed therein, so that the electrons of the mixed gas sealed in the emitting cell 100 are accelerated and collide with gas atoms. Meanwhile, the electrons hit gas atoms, the atoms are ionized to be high-speed electrons and ions, thereby making the discharge gas to be in plasma state and consequently generating ultraviolet (UV) light. By exciting phosphor in the emitting cell 100 with the UV light, red (R), green (G), blue (B) visible light can be generated and display an image.

In the PDP, the emitting cells belonging to the same row generally are configured with one scan electrode. If a PDP meets a VGA standard, which has a resolution of 852×480 pixels, the PDP must be configured to have at least 480 scan electrodes. With advances of science and technology, the sizes of the PDPs are larger and the resolutions of the PDPs are higher; therefore the quantity of the configured scan electrodes for one PDP becomes greater. In order to complete the scanning of all scan electrodes in a frame period, a “Dual Scan” scanning method is provided by the prior art, which firstly divides the panel of one PDP into upper and lower scanning regions, and then separately and simultaneously scans the two scanning regions in the same frame period, thus speeding up the scanning of the whole panel.

However, when the scan electrodes are scanned by the conventional “Dual Scan” scanning method, the driving waveforms are not easily adjusted because of a large difference between discharging properties of the upper and lower scanning regions. This makes the operation voltages of the scanning regions different and causes no voltage margin for the dual scan PDP.

### SUMMARY

It is therefore an aspect of the present invention to provide a method for driving a plasma display panel, which makes the operation voltages of the scanning regions similar, to effectively drive the PDP.

According to one preferred embodiment of the present invention, the method includes dividing a plasma display panel, inclusive of stripe ribs, into at least two scanning regions. Each of the scanning regions has a plurality of scan electrodes and a plurality of common electrodes, and these electrodes are arranged in an interlaced fashion according to an electrode arrangement sequence. Then, emitting cells in each scanning region are addressed, and a scanning direction of each scanning region corresponds to the electrode arrangement sequence of the same scanning region.

It is another aspect of the present invention to provide a plasma display panel, of which a scanning direction of each scanning region corresponds to its is electrode arrangement sequence. The difference between the discharging properties of scanning regions is reduced, and the voltage margin of PDP is enlarged with the electrode arrangement sequence depending on scan direction.

According to another preferred embodiment of the present invention, the plasma display panel has an upper substrate and a lower substrate, and a plurality of stripe ribs are configured on an inner surface of the lower substrate. The plasma display panel comprises at least two scanning regions and a drive circuit, and each of the scanning regions comprises a plurality of scan electrodes and a plurality of common electrodes.

The scan electrodes and the common electrodes are configured on the upper substrate and are arranged in an interlaced fashion according to an electrode arrangement sequence. The drive circuit is also electrically connected to the scan electrodes and the common electrodes and it is connected to address electrode above lower substrate to address the emitting cells of each of the scanning regions. A scanning direction of the drive circuit provided for each of the scanning regions corresponds to the electrode arrangement sequence of the same scanning region.

It is to be understood that both the foregoing general description and the following detailed description are examples and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a schematic top view showing the electrode structure of a conventional PDP;

FIG. 2A is a schematic view of addressing scan electrodes and common electrodes from the scan electrode to the common electrode;

FIGS. 2B and 2C are schematic views of the discharging properties during addressing adjacent emitting cells in the scanning region in FIG. 2A;

FIG. 3A is a schematic view of addressing scan electrodes and common electrodes from the common electrode to the scan electrode;

FIGS. 3B and 3C are schematic views of the discharging properties during addressing adjacent emitting cells in the scanning region in FIG. 3A;

FIG. 4 is a flow chart of one preferred embodiment of the present invention; and

FIGS. 5A, 5B, 6A and 6B are several schematic views of the relative relationships between the scanning direction and the electrode arrangement sequence.

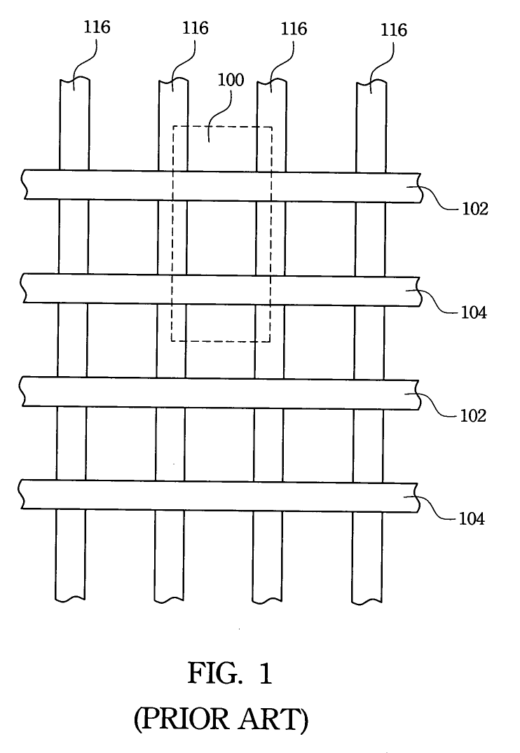

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In order to clearly interpret preferred embodiments of the present invention, the following descriptions firstly explain reasons which cause the large difference between discharging properties of different scanning regions by two examples is having different relative relations between the electrode arrangement sequence and the scanning direction of their own scan electrodes and common electrodes.

First of all, some designations are determined for clear description. A scan electrode of the following embodiments and drawings is designated as X, a common electrode is designated as Y, an address electrode is designated as W, ions are designated as i and electrons are designated as e.

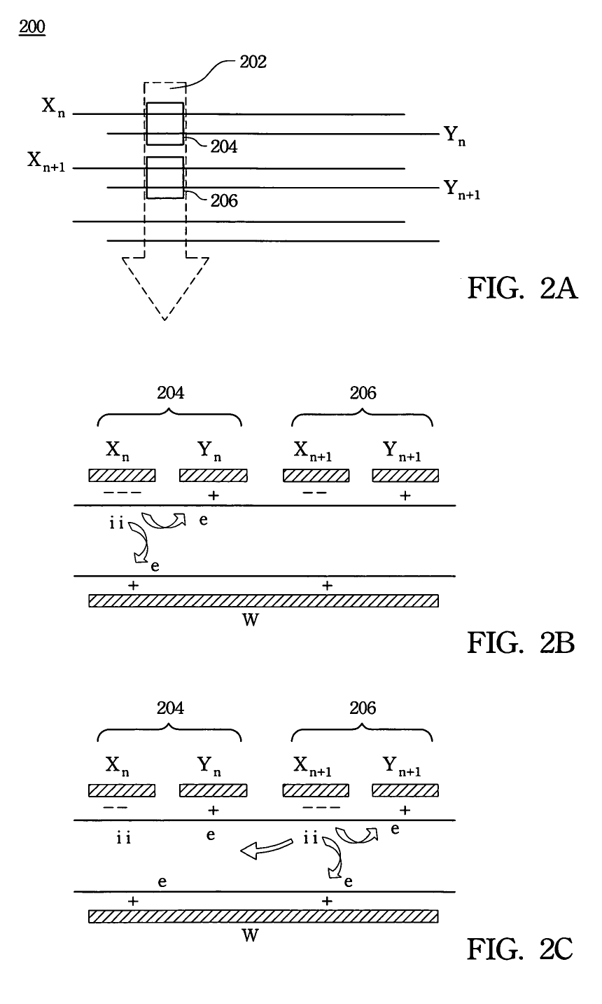

FIG. 2A is a schematic view of addressing scan electrodes and common electrodes (by scanning from the X electrode to the Y electrode) in a scanning region. The scanning region 200 has a plurality of stripe ribs (not shown in FIG. 2A), and the scanning direction for addressing the scanning region 200 follows from the scan electrode X to the common electrode Y. FIGS. 2B and 2C are schematic views of the discharging properties during addressing adjacent emitting cells in the scanning region 200 in FIG. 2A. The following descriptions are made with references to FIGS. 2A, 2B and 2C.

As illustrated in FIG. 2A, the scanning region 200 has a plurality of scan electrodes X, Xn+1, . . . and a plurality of common electrodes Yn, Yn+1, . . . and the scan electrodes and the common electrodes are arranged in an interlaced fashion according to an electrode arrangement sequence. The scanning region 200 is addressed according to a scanning direction 202 from the scan electrode Xn to the common electrode Yn. More particularly, the scan electrode Xn and the common electrode Yn are addressed (as illustrated in FIG. 2B), and then the scan electrode Xn+1 and the common electrode Yn+1 are addressed in turn (as illustrated in FIG. 2C).

Moreover, emitting cells 204 and 206 communicate with each other because there is no rib between emitting cells 204 and 206. When two interconnected emitting cells sequentially discharge, the charges (e.g. electrons or ions) inside one emitting cell may move to the adjacent emitting cell. Under the scanning manner of FIG. 2A, the ions i of the next emitting cell 206 will move to the previous emitting cell 204 and neutralize the electrons e accumulated on the common electrode Yn and the address electrode W. The charges moving from the emitting cell 206 are ions i.

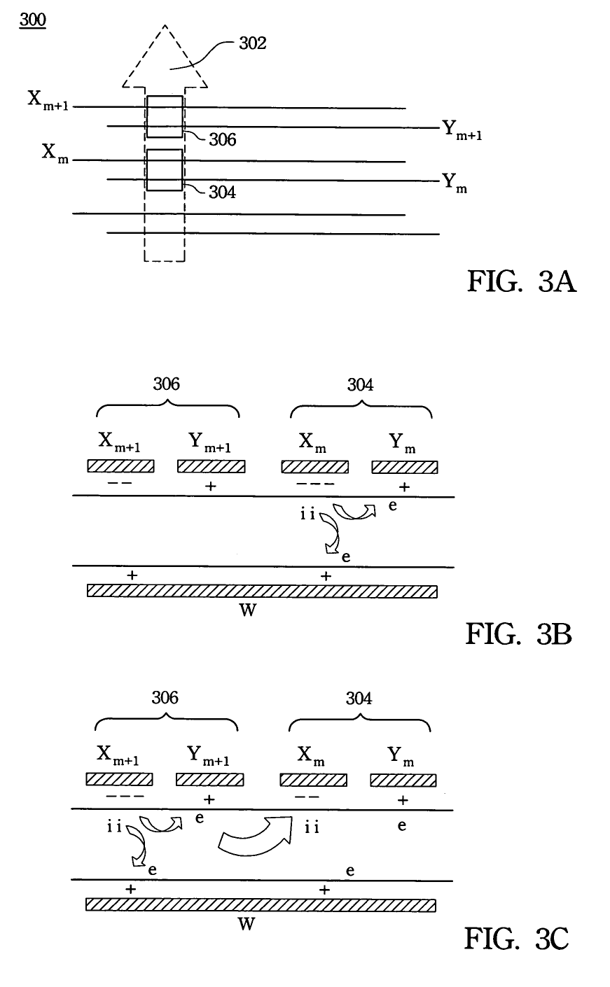

FIG. 3A is a schematic view of addressing scan electrodes and common electrodes (by scanning from the Y electrode to the X electrode) in a scanning region. The scanning region 300 has a plurality of stripe ribs (not shown in FIG. 3A), and the scanning direction for addressing the scanning region 300 follows from the common electrode Y to the scan electrode X, which is different from that illustrated in FIG. 2A. FIGS. 3B and 3C are schematic views of the discharging properties during addressing adjacent emitting cells in the scanning region 300 in FIG. 3A. The following descriptions are made with references to FIGS. 3A, 3B and 3C.

As illustrated in FIG. 3A, the scanning region 300 has a plurality of scan electrodes Xm, Xm+1, . . . and a plurality of common electrodes Ym, Ym+1, . . . , and the scan electrodes and the common electrodes are arranged in an interlaced fashion according to an electrode arrangement sequence. The scanning region 300 is addressed according to a scanning direction 302 from the common electrode Ym to the scan electrode Xm. More particularly, the common electrode Ym and the scan electrode Xm are addressed (as illustrated in FIG. 3B), and then the common electrode Ym+1 and the scan electrode Xm+1 are addressed in turn (as illustrated in FIG. 3C).

Moreover, emitting cells 304 and 306 communicate with each other because there is no rib between emitting cells 304 and 306. When two interconnected emitting cells discharge sequentially, the charges (e.g. electrons or ions) inside one emitting cell will move to the adjacent emitting cell. Under the scanning manner of FIG. 3A, the electrons e of the next emitting cell 306 may move to the previous emitting cell 304 and neutralize the ions i accumulated on the scan electrode Xm. The charges moving from the emitting cell 306 are electrons e.

Accordingly, when the scanning is performed according to the scanning direction 202 in FIG. 2A, the ions i of the next emitting cell 206 may move to the previous emitting cell 204; when the scanning is performed according to the scanning direction 302 in FIG. 3A, the electrons e of the next emitting cell 306 may move to the previous emitting cell 304. In other words, when two interconnected emitting cells discharge sequentially, the emitting cell 206 in FIG. 2A transfers the ions i, and the emitting cell 306 in FIG. 3A transfers the electrons e, contrarily.

However, the mobility of the electron e is significantly greater than the mobility of the ion i, since the ion i is thousands of times heavier than the electron e. The electron e thus has a greater possibility to neutralize the positive charges accumulated in the adjacent emitting cell. In other words, for the two different scanning directions in FIG. 2A and FIG. 3A, the possibilities of neutralizing the charges accumulated in the adjacent emitting cell are different. If different scanning regions of the same panel have different scanning manners, the difference of discharge behavior between the wall charge distributions is quite huge during sustain period since the different wall charge distributions. This causes the scanning regions, which belong to the same panel but are driven by different scanning manners, to have different discharging properties, and thus the driving waveforms will have no driving margin for the PDP of dual scan.

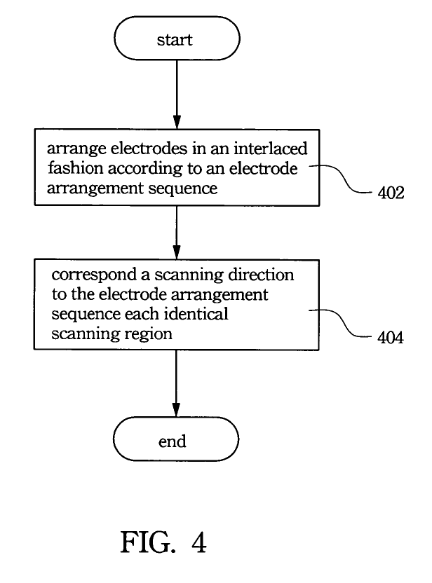

FIG. 4 is a flow chart of one preferred embodiment of the present invention. For solving the foregoing problem, the preferred embodiment unifies the relative relationships between the scanning direction and the electrode arrangement sequence of every scanning region such that the operation voltages of the scanning regions are similar, and the whole discharging property of the panel is effectively adjusted.

As illustrated in FIG. 4, the method firstly divides a plasma display panel having stripe ribs into at least two scanning regions. Each of the scanning regions has a plurality of scan electrodes and a plurality of common electrodes, and these electrodes are arranged in an interlaced fashion according to an electrode arrangement sequence (step 402). Then, the electrodes in each scanning region are addressed, and a scanning direction of each scanning region corresponds to the electrode arrangement sequence of the same scanning region (step 404).

According to the preferred embodiment, every scanning region has the same relative relationship between the scanning direction and the electrode arrangement sequence of the same scanning region. That is, every scanning region is addressed according to the scanning direction from the scan electrode to the common electrode, or every scanning region is addressed according to the scanning direction from the common electrode to the scan electrode. Moreover, the two scanning regions can have different or the same electrode arrangement sequences.

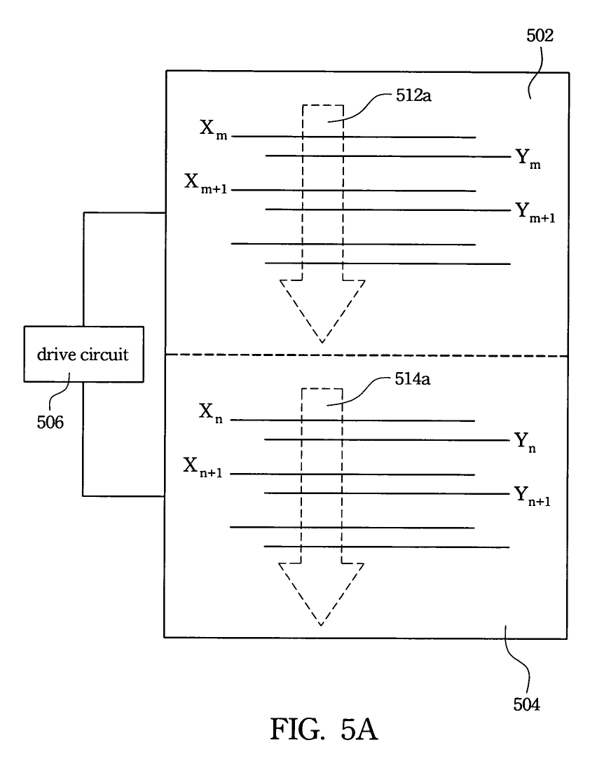

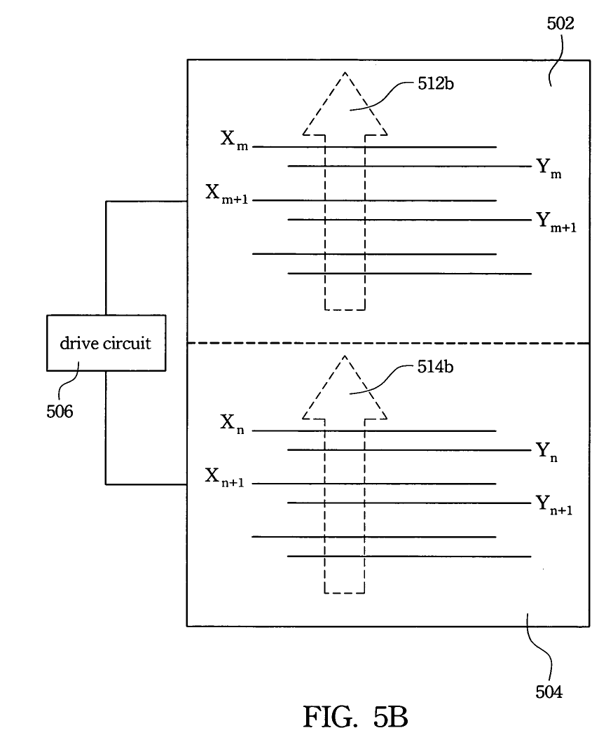

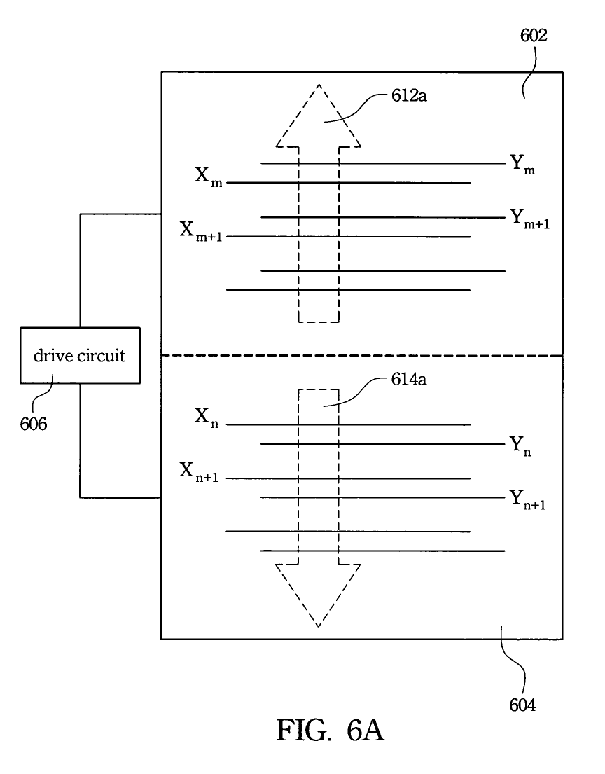

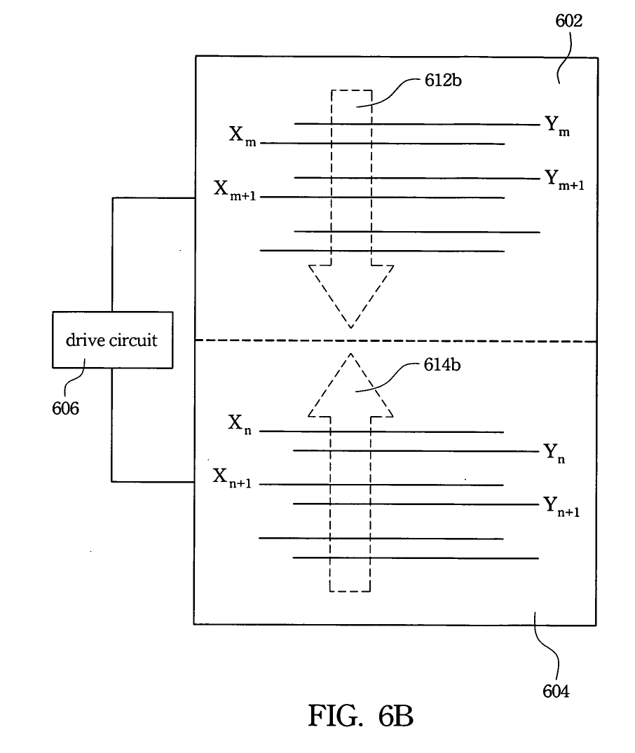

FIGS. 5A, 5B, 6A and 6B are several schematic views of the relative relationships between the scanning direction and the electrode arrangement sequence. The two scanning regions in FIGS. 5A and 5B have the same electrode arrangement sequence, and the two scanning regions in FIGS. 6A and 6B have different electrode arrangement sequences. The plasma display panel of the preferred embodiment has an upper substrate and a lower substrate, and a plurality of stripe ribs are configured on an inner surface of the lower substrate.

As illustrated in FIGS. 5A and 5B, a plasma display panel is divided into at least two scanning regions 502 and 504. Each of the scanning regions 502 and 504 comprises a plurality of scan electrodes X and a plurality of common electrodes Y configured on the upper substrate. In each of the two scanning regions 502 and 504, the scan electrodes X and the common electrodes Y are arranged in an interlaced fashion according to the same electrode arrangement sequence.

A drive circuit 506 is electrically connected to the scan electrodes X and the common electrodes Y and is arranged to address the electrodes X and Y of each of the scanning regions 502 and 504. For the scanning regions 502 and 504, a scanning direction provided by the drive circuit 506 must correspond to its own electrode arrangement sequence such that every scanning region has the same relative relationship between the scanning direction and the electrode arrangement sequence of the same scanning region.

As illustrated in FIG. 5A, the scanning regions 502 and 504 are addressed according to scanning directions 512a and 514a, respectively, i.e. scanning from the scan electrode X to the common electrode Y. Alternatively, as illustrated in FIG. 5B, the scanning regions 502 and 504 are addressed according to scanning directions 512b and 514b, respectively, i.e. scanning from the common electrode Y to the scan electrode X.

In another aspect, as illustrated in FIGS. 6A and 6B, a plasma display panel is divided into at least two scanning regions 602 and 604. Each of the scanning regions 602 and 604 comprises a plurality of scan electrodes X and a plurality of common electrodes Y configured on the upper substrate. In each of the two scanning regions 602 and 604, the scan electrodes X and the common electrodes Y are arranged in an interlaced fashion according to the same electrode arrangement sequence.

A drive circuit 606 is electrically connected to the scan electrodes X and the common electrodes Y and is arranged to address the electrodes X and Y of each of the scanning regions 602 and 604. For the scanning regions 602 and 604, a scanning direction provided by the drive circuit 606 must correspond to its own electrode arrangement sequence such that every scanning region has the same relative relationship between the scanning direction and the electrode arrangement sequence of the same scanning region.

As illustrated in FIG. 6A, the scanning regions 602 and 604 are addressed according to scanning directions 612a and 614a, respectively, i.e. scanning from the scan electrode X to the common electrode Y. Alternatively, as illustrated in FIG. 6B, the scanning regions 602 and 604 are addressed according to scanning directions 612b and 614b, respectively, i.e. scanning from the common electrode Y to the scan electrode X.

In conclusion, the scanning direction and the electrode arrangement sequence of the scanning regions have the same relative relationship in the preferred embodiment. The preferred embodiment makes the operation voltages of scanning regions similar and decreases the difference between the discharging properties of the scanning regions. By the design of the scanning direction corresponding to its electrode arrangement sequence, the preferred embodiment can effectively adjust the whole discharging property of the panel and thereby enlarge the driving margin of the PDP.

It is noted that, although the above-mentioned descriptions interpret the preferred embodiment of the present invention by only two scanning regions, the persons skilled in the art should understand that the panel can be divided into more than two scanning regions when the panel size of the plasma display panel becomes larger or the resolution thereof becomes higher (e.g. higher than XGA 1024×768 pixels or more). As long as the scanning direction and the electrode arrangement sequence of at least two scanning regions on one panel have the same relative relationship, the panel incorporates the spirit of the present invention and falls within the scope of the following claims.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for driving a plasma display panel having stripe ribs, the method comprising:
dividing the plasma display panel into at least two scanning regions, wherein each of the scanning regions has a plurality of scan electrodes and a plurality of common electrodes, and the scan electrodes and the common electrodes are arranged in an interlaced fashion according to an electrode arrangement sequence; and
addressing emitting cells of each of the scanning regions, wherein a scanning direction of each of the scanning regions corresponds to the electrode arrangement sequence of the same scanning region.

2. The method of claim 1, wherein every scanning region has the same relative relationship between the scanning direction and the electrode arrangement sequence of the same scanning region.

3. The method of claim 1, wherein every scanning region is addressed according to the scanning direction from the scan electrode to the common electrode.

4. The method of claim 1, wherein every scanning region is addressed according to the scanning direction from the common electrode to the scan electrode.

5. The method of claim 1, wherein the two scanning regions have different electrode arrangement sequences.

6. The method of claim 1, wherein the two scanning regions have the same electrode arrangement sequence.

7. A method for driving a plasma display panel having stripe ribs, wherein the plasma display panel is divided into at least two scanning regions, and each of the scanning regions has a plurality of scan electrodes and a plurality of common electrodes, the method characterized by:
arranging the scan electrodes and the common electrodes in an interlaced fashion according to an electrode arrangement sequence; and
addressing emitting cells of each of the scanning regions according to a scanning direction, wherein every scanning region has the same relative relationship between the scanning direction and the electrode arrangement sequence of the same scanning region.

8. The method of claim 7, wherein every scanning region is addressed according to the scanning direction from the scan electrode to the common electrode.

9. The method of claim 7, wherein every scanning region is addressed according to the scanning direction from the common electrode to the scan electrode.

10. The method of claim 7, wherein the two scanning regions have different electrode arrangement sequences.

11. The method of claim 7, wherein the two scanning regions have the same electrode arrangement sequence.

12. A plasma display panel having an upper substrate and a lower substrate, and a plurality of stripe ribs are configured on an inner surface of the lower substrate, the plasma display panel comprising:
at least two scanning regions, wherein each of the scanning regions comprises:
a plurality of scan electrodes, configured on the upper substrate;
and
a plurality of common electrodes, configured on the upper substrate, and the scan electrodes and the common electrodes are arranged in an interlaced fashion according to an electrode arrangement sequence; and
a drive circuit, electrically connected to the scan electrodes, the common electrodes and address electrodes, and arranged to address emission cells of each of the scanning regions, wherein a scanning direction of each of the scanning regions corresponds to the electrode arrangement sequence of the same scanning region.

13. The plasma display panel of claim 12, wherein every scanning region has the same relative relationship between the scanning direction and the electrode arrangement sequence of the same scanning region.

14. The plasma display panel of claim 12, wherein the drive circuit is arranged to address every scanning region according to the scanning direction from the scan electrode to the common electrode.

15. The plasma display panel of claim 12, wherein the drive circuit is arranged to address every scanning region according to the scanning direction from the common electrode to the scan electrode.

16. The plasma display panel of claim 12, wherein the two scanning regions have different electrode arrangement sequences.

17. The plasma display panel of claim 12, wherein the two scanning regions have the same electrode arrangement sequence.
